(19) United States
(12) Patent Application Publication
(10) Pub. No.: US 2016/0073590 A1
(43) Pub. Date: Mar. 17, 2016

(54) CONTAINER WITH TEAR-AWAYS

(71) Applicant: Jeff Brust, Fresno, CA (US)

(72) Inventor: Jeff Brust, Fresno, CA (US)

(21) Appl. No.: 14/484,123

(22) Filed: Sep. 11, 2014

(51) Int. Cl. A01G 9/02; B65D 6/24; B29C 49/48; B65D 8/00

(52) U.S. Cl. CPC A01G 9/02; B65D 11/02; B65D 11/1893; B29C 49/48; B29C 2049/4879; B29L 2031/7004

(57) ABSTRACT

Described herein are containers with tear-aways. The tear-aways make the containers easier to open. Containers described herein include pots with a closed bottom and an open top. These pots may be cylindrical, conical, rectangular, or any other shape. The pots may be made with a variety of materials, such as high-density polyethylene (HDPE) which is very dense and hard to tear. Tear-aways may be placed in various positions on a pot such that portions of the pot adjacent to the tear-aways may be separated from each other with ease. Tear-aways may also include hardened ends configured to be pulled.

### TECHNICAL FIELD

The present technology pertains to containers, and more specifically to containers with tear-aways.

### BACKGROUND

Containers are commonly used to store or transport objects such as plants. Containers that hold plants, commonly known as pots, are traditionally made of terracotta but today are typically made of plastic. In many cases, relatively resilient materials such as high-density polyethylene, a petroleum (HDPE) based polyethylene thermoplastic, is used in the production of containers.

Occasionally, items in containers must be removed. For example, plants are often repotted into larger or smaller pots. Different sized pots are required to fit a plant's root system. When removing a plant from a pot, a worker may accidently break a plant. Some workers may use utility knives to quickly open a pot. However, this method may increase an employer's potential liability. Thus, a better container is needed in the art.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In embodiments described herein, containers with tear-aways are described. For example, pots made from various materials, such as HDPE, may include tear-aways allowing a user to quickly and easily remove a plant from a pot. For instance, pots may be made using reconstituted paper, resin, polymers (e.g., HDPE), etc. By using tear-aways, users will not be at risk of injuring themselves with a knife. Further, users will break fewer plants since they will not need to pull a plant out of a pot. In some embodiments, tear-aways may include, or be completely made of a material other than the non-tear-away portions of the pot (e.g., a foreign material may be co-molded or co-extruded) during the manufacturing process. In any case, as described herein, pots may be designed to remove a plant from an opening, however it would be beneficial to make the opening of a pot wider to remove its contents.

Containers described herein include pots with a closed bottom and an open top, such that a plant may extrude from an open side of a pot. Pots may be of different shapes. For example, some pots may be cylindrical in shape, meaning they have a circular enclosed end (e.g., a base), with a cylindrical shaped portion extending from the circular enclosed end, while the end opposite from the circular enclosed end does not enclose a pot. Similarly, a pot may be rectangular in shape such that one wall of the rectangular-shaped pot is open, such that a plant may extrude from the opening. In some embodiments, a pot may be conical in shape, such that the bottom end of a container that is enclosed has a smaller diameter than the opposite end that is not enclosed. Of course, bottom and top are relative terms. However, as use herein, top refers to the generally open side of a pot that is typically in the direction of plant growth outside of soil. As used herein, bottom refer to the generally closed side of the pot, often used to rest the pot of a surface, and often supports soil and a plant above the bottom. Various embodiments and shapes of pots will be apparent to one skilled in the art from the embodiments described herein and the accompanying figures. Further, while in many embodiments only one container is described, more than one may be connected and tear-aways may extend across more than one container, to allow for the opening of many containers.

Further, as will be described below in additional detail, the term “tear-aways” refers to a portion of a container configured to separate portions of that container. Tear-aways are typically weaker portions of a container than non-tear-away portions. For instance, a tear-away may be a perforated strip of plastic on the side of a pot, such that when it is pulled the pot is split such that a plant may easily be removed. In some embodiments, a tear-away may be portions of a container that are relatively thinner than other portions of the container, such that they are easier to tear compared to thicker portions of the container.

Disclosed herein are containers, and methods to create containers, that comprise at least one tear-away. Disclosed are pots made of plastics, paper, rubbers, resins, or some other material (or combination thereof) that comprise tear-aways configured to allow a user to easily open a pot and remove a plant.

As will be described in greater detail below, a container may have one or more tear-aways. A container may include two or three tear-aways that extend from one end of a container to another. Some cylindrical or conical containers may have tear-aways extend around the circumference of the container. In some embodiments, containers may have tear-aways that extend in a spiral fashion along a container.

Further, tear-aways may include a portion of plastic configured be pulled in order to remove at least a portion of the respective tear-away. For instance, a tear-away may have a hard tab at an end of the tear-away configured such that a user may easily pull the tear-away. As described herein, tabs may extend beyond an open side of a container (e.g., a side of a container from which a plant may extrude). In some embodiments, a tear-away may include a loop that may easily be pulled by a user. In some embodiments, a tear-away may be reinforced compared to areas of a pot that are not reinforced such that the tear-away may be removed with less force.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an example container with tear-aways;

FIG. 2 illustrates an example container with tear-aways;

FIG. 3 illustrates an example container with tear-aways;

FIG. 4 illustrates an example container with tear-aways;

FIG. 5 illustrates an example container with a tear-away that extends around the circumference of a container;

FIG. 6 illustrates an example container with a tear-away that extends around the circumference of a container;

FIG. 7 illustrates an example container with a tear-away;

FIG. 8 illustrates an example container with a tear-away;

FIG. 9 illustrates an example container with a tear-away;

FIG. 10 illustrates an example container;

FIG. 11 illustrates an example container with a tear-away that extends from the top of the side of a wall of a container through the enclosed end of the container;

FIG. 12 illustrates an example container;

FIG. 13 illustrates an example container with a tear-aways;

FIG. 14 illustrates an example rectangular-shaped container with a tear-aways;

FIG. 15 illustrates an example method embodiment of creating a container with tear-aways; and

FIG. 16 illustrates an example method embodiment of removing a plant from a container comprising tear-aways.

### DESCRIPTION

Various embodiments of the disclosure arc discussed in detail below. While specific implementations are discussed, it should be understood that this is done for illustration purposes only. A person skilled in the relevant art will recognize that other components and configurations can be used without parting from the spirit and scope of the disclosure.

Containers described herein allow a user to easily remove a plant from that container. The containers include tear-aways which allow users to separate portions of a container. In response to separating the portion of the container, a plant may be removed easily and without breaking.

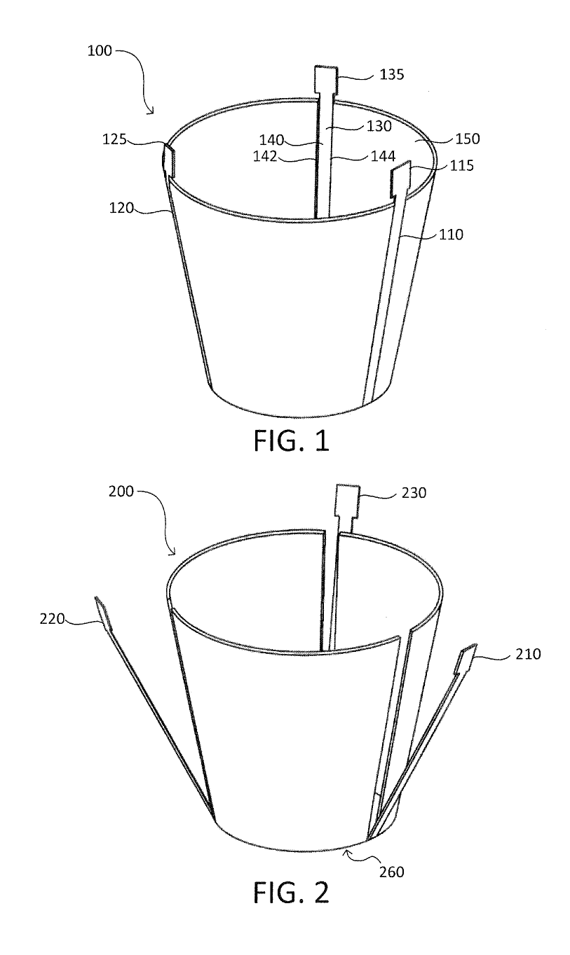

FIG. 1 illustrates an example container 100 with tear-aways 110, 120, 130. In some embodiments described herein, tear-aways 110, 120, 130 comprise tabs 115, 125, 135 that when pulled with a particular amount of force detach at least a portion of a tear-away, thus separating (or bifurcating) at least a two portions of a container. Tabs 115, 125, 135 may be positioned at a distal end of a tear-away 110, 120, 130, such that when a tab 115, 125, 135 is pulled at least a portion, if not all, of the tear-away 110, 120, 130 is detached from the container 100.

In some embodiments, a tear-away 130 may be a strip wherein a center portion 140 of the strip is thicker than the two edge portions 142, 144 of the strip. For instance, a tear-away may have a center portion 140 with the same thickness as the non-tear-away portions of a container 150, with two edge portions 142, 144 that are thinner than both the center portion 140 of the tear-away and the non-tear-away portions of a container 150.

In some embodiments, the center portion 140 of a tear-away may be reinforced, relative to the non-tear-away portions of a container 150, such that it is easier to pull away. In some embodiments, a tear-away 110 may be a strip wherein the two edges portions 142, 144 of the strip are perforated, or scored in a manner such that when a distal end of a tear-away (e.g., tabs 115, 125, 125) are pulled at least a portion of a tear-away 110 is separated from a container 100. In some embodiments, a tear-away may have more than two edge portions. For instance, the distal end of a strip opposite from the end configured to be pulled may be an edge portion.

In some embodiments, tear-aways 110, 120, 130 may be easier to tear in one direction than another. For instance, a tab 115, 125, 135 may easily be pulled down such that the tear-away is removed from the open side of the container 100 downward, however, more force would be required for roots of a plant to cause a tear-away 115, 125, 135 to separate from a container 100 by pushing against the inner walls of a container. In some embodiments, this may be accomplished by configuring scores, or perforations, in a manner such that a tear-away 110, 120, 130 created by the scores/perforations is much easier to pull and separate from non-tear-away portions of a container 150 than if they were to be pulled in the opposite (wrong) direction. Whatever the type of tear-away 110, 120, 130, in various embodiments tear-aways 110, 120, 130 are fabricated in the same fabrication process used to create the container 100 itself.

FIG. 2 illustrates an example container 200 with tear-aways 210, 220, 230. In some embodiments, tear-aways 210, 220, 230 may be configured such that when the tear-aways 210, 220, 230 are at least partially removed, a space may be created between the inner-walls of a container 200 and the contents of the container. In embodiments described herein, at least a portion of the contents of a container may be forced against at least a portion of the inner surface of a container 200. In some embodiments, portions of the content of the container may apply a substantially equal amount of pressure to the inner surfaces of a container. For instance, the tear-aways 210, 220, 230 may be configured such that after the tear-aways are pulled, a potted plant would be easy to remove since there is a gap between the plant and/or soil and the inner wall of the container 200.

In some embodiments, a container 200 may be configured such that when the tear-aways 210, 220, 230 are at least partially separated from the walls of a container 200, the walls of the container 200 may lay substantially flat in comparison with a bottom portion 260, or base, of a container.

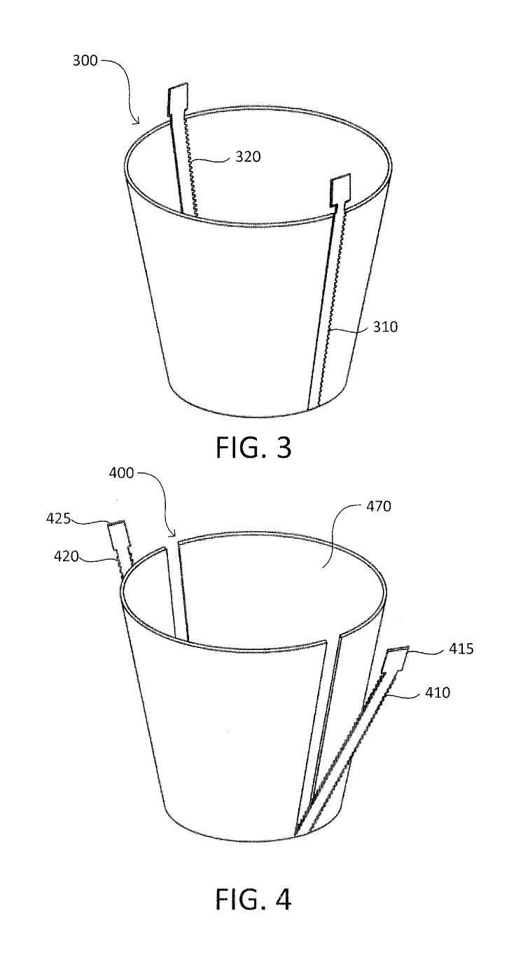

FIG. 3 illustrates an example container 300 with tear-aways 310, 320. Similar to FIG. 1, container 300 is configured to open, or at least create space within the container 300 to making the contents of container 300 easier to remove, since less pressure is put on the contents of the container when the tear-aways 310, 320 are at least partially separated from the container 300. FIG. 4 similarly illustrates an example container 400 with tear-aways 410, 420. As with FIG. 2, in some embodiments, tear-aways 410, 420 may be at least partially removed by pulling tabs 415, 425 away from the inside of a container 470.

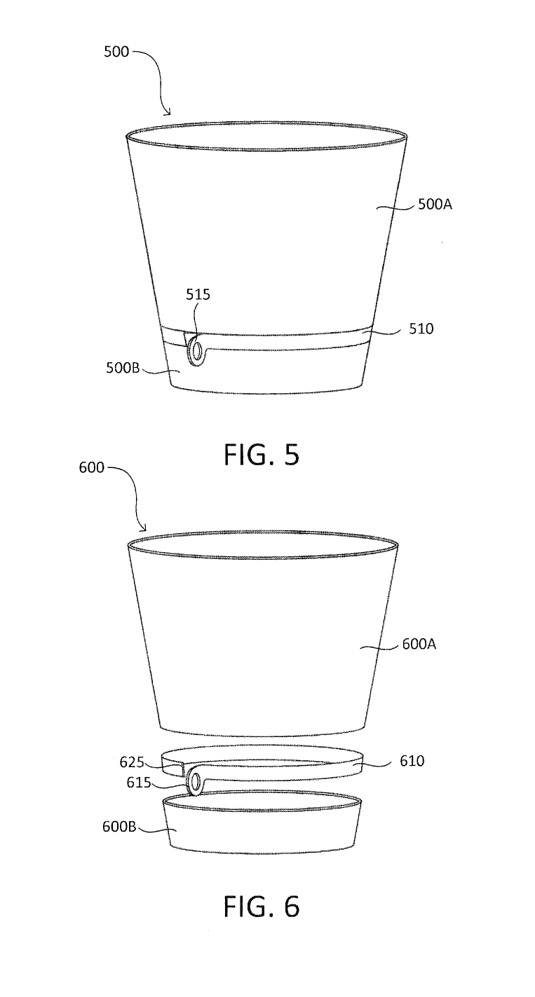

FIG. 5 illustrates an example container 500 with a tear-away 510. Similar to the tabs 415, 425 in FIG. 4, for example, tear-away 510 comprises a tab 515 in the shape of a loop. Tabs 515, as used herein, may refer to a hardened portion of material at a distal end of a tear-away 510. Tabs 515 may have various shapes and sizes, such as rectangles, circles, circles with holes in them (i.e., loops), etc.

As illustrated in FIG. 5, in some embodiments a tear-away 510 may extend around surface of a container 500 (e.g., the circumference of a cylindrical or conical container, or the walls of a rectangular shaped container), such that the container's top 500A and bottom 500B are bifurcated allowing the contents of the container to be removed with ease.

FIG. 6 illustrates an example container 600 with a tear-away 610 that extends around the circumference of the container 600. In some embodiments, tear-away 610 may be substantially perpendicular to the base, or enclosed end, of a container 600 (as well as a top, or open side of a container 600). Of course, in some embodiments a tear-away 610 may extend around the sides of a container 600 above the base at an angle that is not precisely parallel to the base of the container 600. Note that although tear-away 610 is completely separated from the top 600A and bottom 600B portions of container 600, in some embodiments a portion of the tear-away 610 may still be attached to a container 600 after it is pulled. For example, a tear-away 610 may have two ends—one with a tab 615 for pulling, and one without a tab 625. The end of the tear-away without a tab 625 may stay connected to a container 600 in some embodiments, or the tear-away 610 may be completely removed from the container 600.

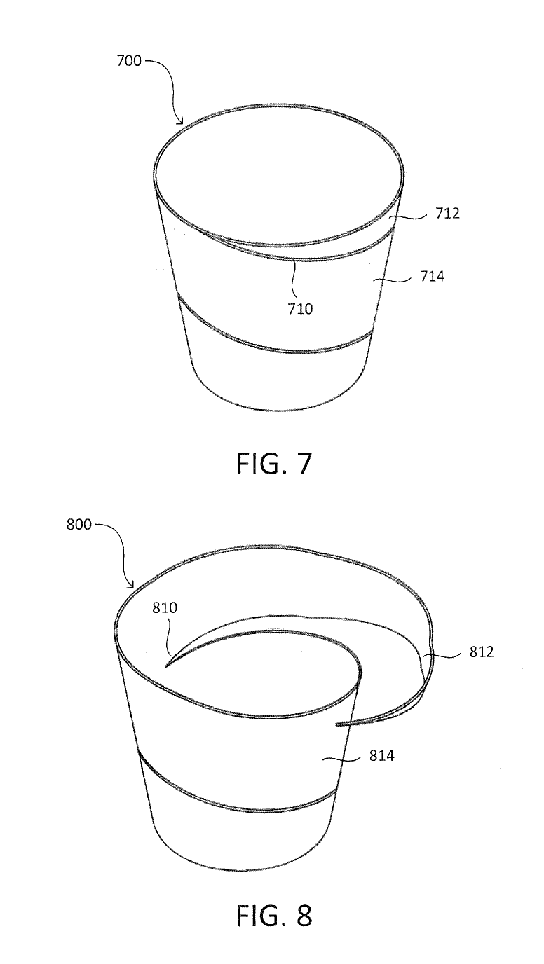

FIG. 7 illustrates an example container 700 with a tear-away 710. As shown in FIG. 7, a tear-away 710 may also include a single thin, or perforated, portion of material configured to make portions 712, 714 of container 700 easier to separate (e.g., the portions 712, 714 may be separated with less force than if the tear-away 710 was absent). It should be noted that a tear-away 710 that is a thin portion of the container may be implemented in various directions as the containers shown in FIGS. 1-6, among others.

In some embodiments, tear-away 710 is configured in a spiral manner such that portions 712, 714 of the container 700 are separated from each other, while the container 700 technically remains in one piece (although it may then be unfit for being a container). FIG. 8 illustrates an example container 800 with a tear-away 810 wherein the walls of container 800 are removed in a spiral manner as tear-away 710 is used to disconnect portions 812, 814 of container 800.

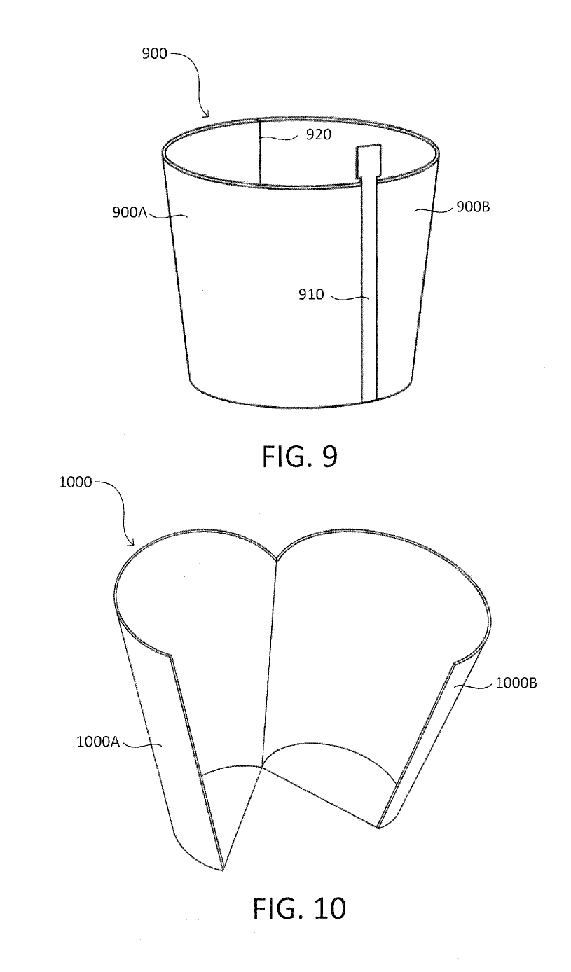

FIG. 9 illustrates an example container 900 with a tear-away 910. As illustrated, in some embodiments, portions of a container 900 may be separated via a tear-away 910 such that the container 900 may be split in half. For instance, a container 900 may comprise at least one hinge 920 that keeps portions 900A, 900B of a container 900 connected on at least one side. For example, FIG. 10 illustrates an example container 1000 with separated portions 1000A, 1000B. In some embodiments, a tear-away 910 such as shown in FIG. 9 may be completely removed from a container 1000 as shown in FIG. 10. Alternatively, in some embodiments a tear-away may remain connected after separating a container 1000. As shown in FIG. 10, in some embodiments a tear-away may be used to separate portions 1000A, 1000B of a container 1000 wherein one of the side walls may be bent such that the portions 1000A, 1000B each comprise half of the container 1000 (minus any removed tear-away portions).

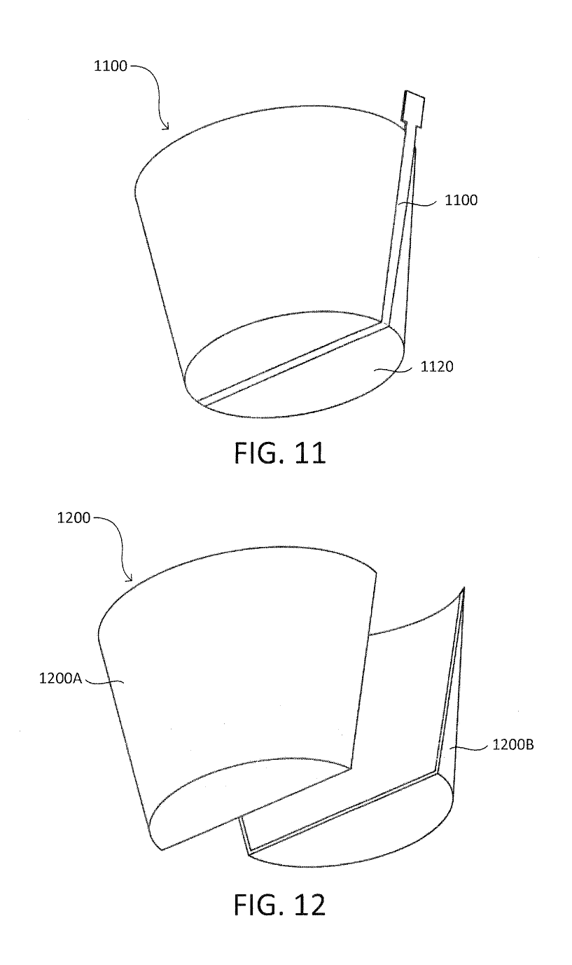

FIG. 11 illustrates an example container 1100 with a tear-away 1110 that extends from the top of the side of a wall of container 1100 through the enclosed end (e.g., base) of the container 1120, and in some embodiments up an opposing side wall of container 1100. Herein, although the side walls of a round container such as 1100 may be considered the same wall in some embodiments, for the purposes of explanation an opposing portion of the wall of a cylindrical or conical container may also be referred to as an opposing side wall.

FIG. 12 illustrates an example container with 1200 with separated portions 1200A, 1200B. In this example, a tear-away such as tear-away 1110 shown in FIG. 11 may have been removed from container 1200, bifurcating it into two separated portions 1200A, 1200B. While only one tear-away may be used to separate container 1200 into two portions 1200A, 1200B, it should be understood that multiple tear-aways may be used to separate a container 1200. Further, a container 1200 may be separated into more than two portions 1200A, 1200B. Multiple tear-aways may be used in combination. For instance, one tear-away may extend around the circumference of a container while one or more additional tear-aways may extend perpendicularly relative to the enclosed end of a container.

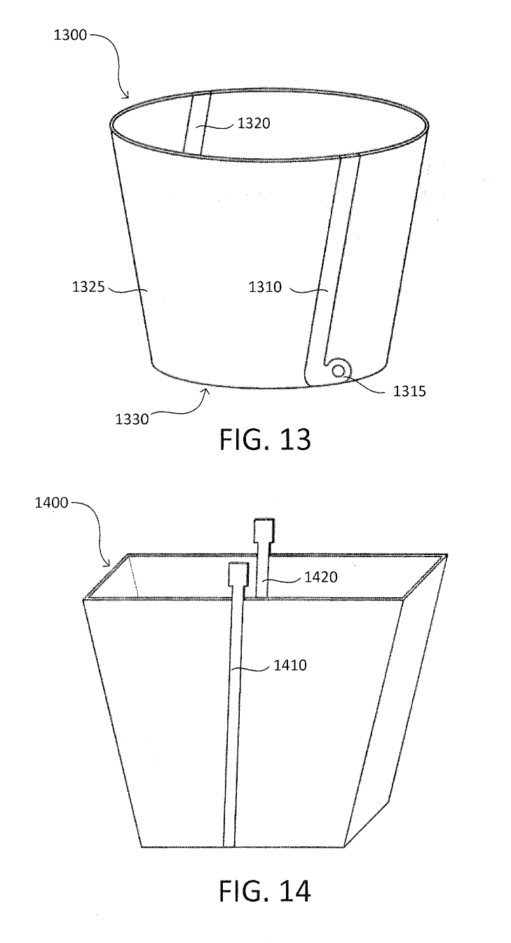

FIG. 13 illustrates an example container 1300 with a tear-aways 1310, 1320 comprising tabs 1315, 1325 located near an enclosed end 1330, or base, of the container 1300. Such a configuration allows a user to place a container 1300 on its base and pull a tear-away 1310, 1320 upwards, towards a user's upper body. Of course, in some embodiments a first portion of the tear-aways 1310, 1320 may be configured to be removed by pulling in one direction, while a second portion of the tear-aways 1310, 1320 are configured to be removed by pulling in a different, or opposite direction.

In some embodiments, a tab 1315 may be flush with the surface of a container 1300. In such a case, a tab 1315 may not catch onto a loose object accidently causing the tab 1315 to be pulled. As described above, although the tab 1315 in FIG. 13 is in the shape of a loop, a tab may be any shape, such as a rectangle, square, circle, etc. In some embodiments, a tear-away 1310 is a strip and comprises a tab 1315 that is wider than the strip.

FIG. 14 illustrates an example rectangular-shaped container 1400 with a tear-aways 1410, 1420. As should be noted, containers 1400 need not be conical or cylindrical. For example, a container comprising tear-aways 1410, 1420 may be rectangular in shape, elliptical, pentagonal, etc. In some embodiments, various versions of tear-aways described herein may be implemented using a container of any shape, such as shown in FIG. 14. For example, a rectangular container 1400 may comprise a tear-away that extends around the sides of container 1400 parallel to the container's enclosed end, such as in the manner shown in FIG. 3 and FIG. 4. Similarly, one wall or edge of a rectangular shaped container 1400 may be configured to act as a hinge in such a manner as shown in FIG. 9 and FIG. 10.

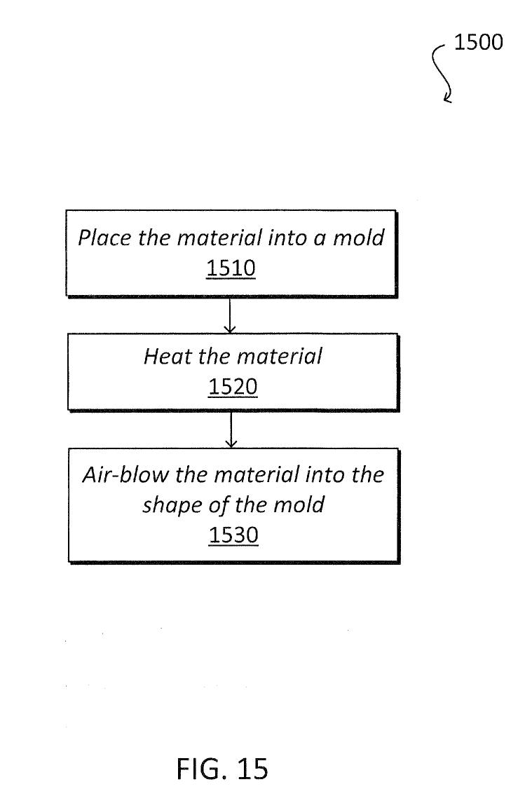

FIG. 15 illustrates an example method embodiment 1500 of creating a container with tear-aways. There are a variety of methods which may be used to create containers out of numerous materials, such as hardened paper, rubber or plastic (e.g., HDPE, etc.), and as such this disclosure will not go in depth into the various method used to create these containers. Also, it should be understood that example method embodiments are shown for example only. Additional or fewer steps may be added or removed from the method embodiments shown herein. In addition, at least portions of the described method diagram shown in FIG. 15 may be performed in a different order, in parallel, or not performed at all.

As shown, method 1500 begins at block 1510, where a material such as a resin or HDPE is placed into a mold. The mold may be formed in such a manner that perforations are placed in the material to create tear-aways. Similarly, the mold may be formed in such a manner that some areas of the material are thinner than others, creating one or more tear-aways.

At block 1520, the material is heated. As described in embodiments herein, the heating allows the material to be malleable such that tear-aways may be inserted. At block 1530, the material is air-blown to assume the shape of the mold, such that the tear-aways become a part of the finished container.

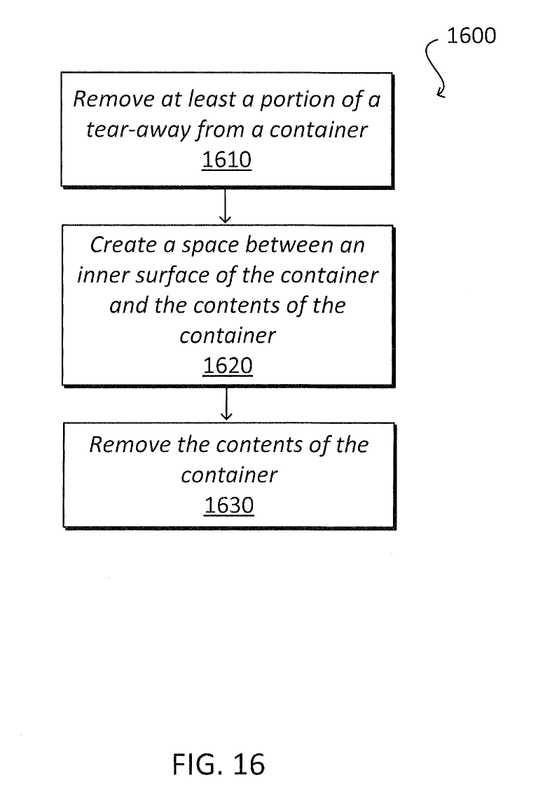

FIG. 16 illustrates an example method embodiment 1600 of removing a plant from a container comprising tear-aways. As with FIG. 15, additional or fewer steps may be added or removed from the method embodiments shown herein. In addition, at least portions of the described method diagram shown in FIG. 16 may be performed in a different order, in parallel, or not performed at all.

Method 1600 begins at block 1610, where at least one tear-away is at least partially removed from a container comprising at least one tear-away. As described herein, tear-aways may come in a variety of shapes and sizes, and tear-aways may include tabs or other material configured to allow a user to grip a distal end of a tear-away. At block 1620, in response to the tear-away being at least partially removed, a space is created between an inner surface of a container and the contents of that container. For example, the contents of a container may include a plant and/or soil. At block 1630, the contents of the container are removed, which may include a plant and/or soil.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further, although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A container comprising:
a side wall including a first side wall portion and a second side wall portion;
a bottom attached to the side wall, the bottom including a first bottom portion and a second bottom portion;
an open side; and
a continuous tear-away that adjoins the first side wall portion to the second side wall portion and the first bottom portion to the second bottom portion, the tear-away including a weakened portion.

2. (canceled)

3. The container of claim 1 wherein the one or more tear-aways extend from the one or more open sides of the container.

4. The container of claim 1 wherein the one or more tear-aways comprise:
two or more edge portions; and
a center portion, wherein the center portion is thicker than the two or more edge portions, the edge portions being the weakened portion.

5. The container of claim 1 wherein the container comprises high-density polyethylene (HDPE).

6. The container of claim 1, wherein the one or more tear-aways are a thinner portion of the container than non-tear-away portions of the container.

7. The container of claim 1, wherein the one or more tear-aways extend around a circumference of the container, and wherein the one or more tear-aways are parallel to a base of the container.

8. The container of claim 1, wherein the one or more tear-aways comprise a tab at a distal end of the tear-away.

9-20. (canceled)

21. The container of claim 8, wherein the tab extends beyond at least one of the one or more open sides.

22. The container of claim 1, wherein the first side wall portion is separatable from the second side wall portion along the weakened portion of the tear-away and the first bottom portion is separatable from the second bottom portion along the weakened portion of the tear-away.

23. The container of claim 1, comprising an opposing side wall, and the continuous tear-away adjoins a first side wall portion of the opposing side wall to the second side wall portion of the opposing side wall.

24. The container of claim 1, wherein the continuous tear-away extends to a second container of the same configuration.

25. A method comprising:
applying a force to a continuous tear-away embedded in a material making up a container for holding a plant, the continuous tear-away adjoins a first side wall portion to a second side wall portion of a side wall, and a first bottom portion to a second bottom portion of a bottom portion, the tear-away including a weakened portion, thereby dividing the container along the weakened portion.

26. The method of claim 25, wherein the applied force is a continuous force effective to divide the container along the weakened portion of the entire continuous tear-away.

27. The method of claim 25, wherein the tear-away extends to a second container, and the applied force is effective to divide the second container.
